(19) United States
(12) Patent Application Publication
(10) Pub. No.: US 2026/0369457 A1
(43) Pub. Date: Nov. 19, 2026

(54) HYBRID WINDING STRUCTURE FOR MAGNETIC COMPONENT

(71) Applicant: Delta Electronics, Inc., Taipei (TW)

(72) Inventors: Dakai Wang, Morrisville, NC (US); Yi-Sheng Chang, Taoyuan City (TW); Pao-Hsiang Chang, Taoyuan City (TW); Misha Kumar, Morrisville, NC (US); Peter Mantovanelli Barbosa, Taoyuan City (TW)

(21) Appl. No.: 19/574,726

(22) Filed: Mar. 23, 2026

Related U.S. Application Data
(60) Provisional application No. 63/776,482, filed on Mar. 24, 2025.

(51) Int. Cl. H01F 27/28; H01F 27/24

(52) U.S. Cl. CPC H01F 27/2804; H01F 27/24; H01F 27/2823; H01F 27/2809

(57) ABSTRACT

A hybrid winding structure for a magnetic component includes at least two PCB-based hybrid winding layers, wherein the magnetic component includes a magnetic core having at least one leg. The at least two PCB-based hybrid winding layers are wound around the at least one leg of the magnetic core, wherein at least one of the at least two PCB-based hybrid winding layers includes a first portion and a second portion, wherein the first portion is configured as PCB Litz wire and disposed at a first magnetic field region of the magnetic component, the second portion is configured as PCB winding and disposed at a second magnetic field region of the magnetic component, and a magnetic field magnitude of the first magnetic field region is higher than a magnetic field magnitude of the second magnetic field region.

### CROSS-REFERENCE TO RELATED APPLICATION

This application claims the benefit of U.S. Provisional Application No. 63/776,482 filed on Mar. 24, 2025. The entire contents of the above-mentioned patent application are incorporated herein by reference for all purposes.

### FIELD OF THE INVENTION

The present disclosure relates to a hybrid winding structure for magnetic component, and more particularly to a hybrid winding structure combining PCB winding and PCB Litz wire.

### BACKGROUND OF THE INVENTION

Wide-band-gap devices have pushed the switching frequency of power supplies from the kilohertz range to the megahertz range. At these higher frequencies, both the skin and proximity effects become much more pronounced, leading to significantly increased eddy current losses.

Litz wire was designed to mitigate these losses by distributing current across many insulated strands. While effective, Litz wire based transformers are physically bulky and require a large three-dimensional volume within the magnetic core, which limits the power density of modern, compact converters and leads to high manufacturing costs.

In response to the demand for miniaturization, PCB winding is now widely used in planar transformers. By utilizing the board's layers as conductors, it offers a dramatically reduced profile and a slim, flat form factor that integrates easily into low-profile enclosures. However, despite its enhanced thermal dissipation characteristics and low cost, standard PCB windings suffer severe AC losses in high-frequency, high H-field environments, such as in high-turn inductors.

PCB Litz wire attempts to bridge this gap. It mimics the multi-stranded design of traditional Litz wire to reduce AC losses while maintaining the highly compact, integrated footprint of a planar component. Although this configuration effectively addresses high-frequency losses within a minimal vertical height, it inherently results in a notable rise in DC resistance due to the increased complexity of the trace routing and via connections.

Therefore, there is a need of providing a hybrid winding structure for the magnetic component to address the drawbacks described above.

### SUMMARY OF THE INVENTION

An object of the present disclosure is to provide a hybrid winding structure for a magnetic component which can adjust winding types included therein based on magnetic field distribution of the magnetic component to achieve optimal overall efficiency.

Another object of the present disclosure is to provide a hybrid winding structure for a magnetic component which can simultaneously achieve low AC losses, minimized DC resistance, and a highly compact and low-profile volume.

In accordance with an aspect of the present disclosure, a hybrid winding structure for a magnetic component is provided. The magnetic component includes a magnetic core having at least one leg. The hybrid winding structure for the magnetic component includes at least two PCB-based hybrid winding layers wound around the at least one leg of the magnetic core. At least one of the at least two PCB-based hybrid winding layers includes a first portion and a second portion. In an embodiment, each of the at least two PCB-based hybrid winding layers includes a first portion and a second portion. The first portion is configured as PCB Litz wire and disposed at a first magnetic field region of the magnetic component, and the second portion is configured as PCB winding and disposed at a second magnetic field region of the magnetic component. The magnetic field magnitude of the first magnetic field region is higher than the magnetic field magnitude of the second magnetic field region.

In an embodiment, the first portion is disposed at the first magnetic field region where a ratio of AC resistance to DC resistance is greater than a predefined threshold value, and the second portion is disposed at the second magnetic field region where the ratio of AC resistance to DC resistance is less than the predefined threshold value. In one embodiment, the predefined threshold value approximately equals 3.

In an embodiment, the magnetic component is an integrated magnetic component including a transformer and an inductor, and the first portion of the at least one of the at least two PCB-based hybrid winding layers is disposed at a boundary between the transformer and the inductor. In one embodiment, the first portion of each of the at least two PCB-based hybrid winding layers is disposed at a boundary between the transformer and the inductor.

In an embodiment, the hybrid winding structure further includes at least one Litz wire layer disposed at the first magnetic field region of the magnetic component.

In an embodiment, the first portion and the second portion of the at least one of the at least two of the PCB-based hybrid winding layers are within a same conductive plane, and the first portion and the second portion are spatially arranged based on a magnetic field distribution of the magnetic component. In one embodiment, the first portion and the second portion of each of the at least two of the PCB-based hybrid winding layers are within a same conductive plane.

In an embodiment, the hybrid winding structure further includes at least one Litz wire layer, wherein the at least one Litz wire layer is configured as one of a primary winding and a secondary winding of the magnetic component, and the at least two PCB-based hybrid winding layers are configured as the other of the primary winding and the secondary winding of the magnetic component.

In an embodiment, the hybrid winding structure further includes at least one PCB winding layer wound around the at least one leg of the magnetic core.

In an embodiment, the PCB Litz wire of the first portion is formed by using a side plating process.

In an embodiment, each of the at least two PCB-based hybrid winding layers includes the first portion disposed at the first magnetic field region of the magnetic component and the second portion disposed at the second magnetic field region of the magnetic component.

In accordance with another aspect of the present disclosure, a hybrid winding structure for a magnetic component is provided. The magnetic component includes a magnetic core having at least one leg. The hybrid winding structure for the magnetic component includes at least one PCB Litz wire layer and at least one PCB winding layer stacked on each other. The at least one PCB Litz wire layer and the at least one PCB winding layer are wound around the at least one leg of the magnetic core. The at least one PCB Litz wire layer is disposed at a first magnetic field region of the magnetic core, and the at least one PCB winding layer is disposed at a second magnetic field region of the magnetic core. The magnetic field magnitude of the first magnetic field region is higher than the magnetic field magnitude of the second magnetic field region.

In an embodiment, the magnetic component includes an inductor, and the first magnetic field region is corresponding to or proximate to an air gap of the magnetic component.

In an embodiment, the magnetic component includes a transformer, and the at least one PCB Litz wire layer and the at least one PCB winding layer are configured as at least one of a primary winding and a secondary winding of the transformer.

In an embodiment, the hybrid winding structure further includes at least one Litz wire layer configured as the other of the primary winding and the secondary winding of the transformer.

In an embodiment, the at least one PCB Litz wire layer includes two PCB Litz wire layers, and the at least one PCB winding layer is located between the two PCB Litz wire layers.

In an embodiment, a plurality of conductive layers in each of the at least one PCB Litz wire layer are interconnected through a side plating process.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1A to FIG. 1C are schematic views illustrating hybrid winding structure according to the embodiments of the present disclosure;

FIG. 2 is a schematic view illustrating a hybrid winding structure according to another embodiment of the present disclosure;

FIG. 3 is a top view of a PCB-based hybrid winding layer according to an embodiment of the present disclosure; and

FIG. 4 is a schematic view illustrating a PCB Litz wire layer which is interconnected through side plating.

### DETAILED DESCRIPTION OF EMBODIMENTS

The present disclosure will now be described more specifically with reference to the following embodiments. It is to be noted that the following descriptions of embodiments of this disclosure are presented herein for purpose of illustration and description only. It is not intended to be exhaustive or to be limited to the precise form disclosed.

The embodiment of the present disclosure provides a hybrid winding structure for a magnetic component including a PCB winding portion and a PCB Litz wire portion, and the PCB winding portion and the PCB Litz portion can be arranged based on the magnetic field distribution of the magnetic component.

By analyzing the magnetic field (H-field) distribution within the magnetic component, PCB Litz wire is selectively configured to dispose at the high magnetic field region to suppress alternating current (AC) losses, while PCB winding is disposed at the low magnetic field region to maintain low direct current (DC) resistance. Accordingly, a trade-off between the AC loss and the DC resistance can be achieved, thereby enhancing the efficiency of the magnetic component. That is, the hybrid winding structure in the embodiments of the present disclosure has the ability to balance the low DC loss of the PCB winding with the low AC loss of the PCB Litz wire based on local magnetic field distribution within the magnetic component.

Notably, in the embodiments of the present disclosure, the PCB Litz wire refers to a printed circuit board (PCB) structure including a Litz winding, wherein the Litz winding is configured to include a plurality of conductive layers forming multiple layers of electrically insulated strands, and the electrically insulated strands are electrically coupled to establish a continuous transposition path, thereby mimicking the multi-stranded design of Litz wire.

In one embodiment, the configuration of the PCB winding portion and the PCB Litz wire portion in the hybrid winding structure is determined by the ratio (FR) of the AC resistance (R_{ac}) to the DC resistance (R_{dc}) :

FR=R_{ac}/R_{dc}

PCB Litz wire is disposed at a high magnetic field region where the calculated ratio FR exceeds a predefined threshold value, e.g., where the ratio FR is greater than 3; and the PCB winding is disposed at a low magnetic field region where the calculated ratio FR is below the predefined threshold value, e.g., where the ratio FR is less than 3.

In some embodiments, the predefined threshold value is not limited to a fixed numerical value and may be determined based on operating frequency, conductor geometry, current density, and acceptable loss trade-offs. In practical implementations, a threshold value of approximately 3 has been found to provide an effective balance between AC loss reduction and DC resistance increase.

In the present disclosure, the configuration of the hybrid winding structure can be implemented into several embodiments. For example, in an embodiment, the PCB winding and the PCB Litz wire are selected to dispose in different layers within the hybrid winding structure; in other embodiment, the PCB winding and the PCB Litz wire are arranged in different portions of a same layer within the hybrid winding structure; or in some other embodiments, the two configurations described above are utilized in combination.

Based on these configurations above, the hybrid winding structure proposed in the embodiments of the present disclosure features high flexibility and adaptability, and it can be utilized in a wide range of high-frequency magnetic components, such as transformers, inductors, integrated magnetic component, to meet specific power density and efficiency requirements thereof.

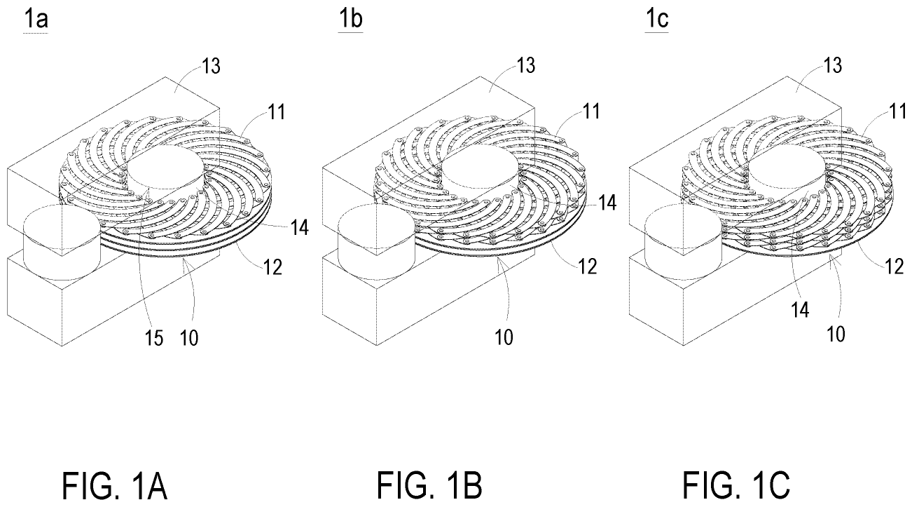

Refer to FIG. 1A. The magnetic component 1a includes a hybrid winding structure 10 and a magnetic core 13. The magnetic core 13 includes at least one magnetic leg 14. The hybrid winding structure 10 is wound around the at least one leg 14 of the magnetic core 13. In one embodiment, preferably but not exclusively, the magnetic component 1a is configured as an inductor. The hybrid winding structure 10 includes N PCB-based winding layers. The N PCB-based winding layers are wound around the magnetic leg 14 of the magnetic core 13. As known, the peak magnetic field typically occurs proximate to or corresponding to the air gap 15 of the magnetic core 13. Accordingly, in some embodiments, as shown in FIG. 1A, FIG. 1B and FIG. 1C, the first M layer(s) (M<N) closer to or corresponding to the air gap 15 of the magnetic core 13 suffers from high magnetic fields are configured as a PCB Litz wire layer 11 to mitigate AC losses. The remaining N−M layer(s) closer to the magnetic core 13 experiences a lower magnetic field are configured as a PCB winding layer 12 to minimize DC resistance. For example, as shown in FIG. 1A, a four-layer magnetic component 1a (i.e., inductor) can be configured with one PCB Litz wire layer 11 and three PCB winding layers 12 (namely N=4 and M=1). In some embodiments, as shown in FIG. 1B, a four-layer magnetic component 1b can be configured with two PCB Litz wire layers 11 and two PCB winding layers 12 (namely N=4 and M=2). In some other embodiments, as shown in FIG. 1C, a four-layer magnetic component 1c can be configured with three PCB Litz wire layers 11 and one PCB winding layer 12 (namely N=4 and M=3). It is noted that the number and arrangement of the layers are not limited to the above embodiments and can be varied depending on frequency requirements.

In the embodiment, the layer closest to the air gap 15 (e.g., the top layer) is replaced with at least one PCB Litz wire layer 11, while the remaining layer(s) farther from the air gap 15 is maintained as at least one PCB winding layer 12. Experimental data indicates that at 270 kHz, the hybrid winding structure 10 including one PCB Litz wire layer 11 and three PCB winding layers 12 reduces total loss by approximately 24% compared to a full PCB winding structure, and maintains lower DC loss compared to a full PCB Litz wire structure.

In the embodiment, the hybrid winding structure 10 includes at least one PCB Litz wire layer 11 and at least one PCB winding layer 12 stacked on each other. The at least one PCB Litz wire layer 11 and the at least one PCB winding layer 12 are wound around the at least one leg 14 of the magnetic core 13. The at least one PCB Litz wire layer 11 is disposed at a first magnetic field region of the magnetic component, and the at least one PCB winding layer 12 is disposed at a second magnetic field region of the magnetic component. The magnetic field magnitude of the first magnetic field region is higher than the magnetic field magnitude of the second magnetic field region. Preferably but not exclusively, the first magnetic field region is corresponding to or proximate to the air gap 15 of the magnetic core 13.

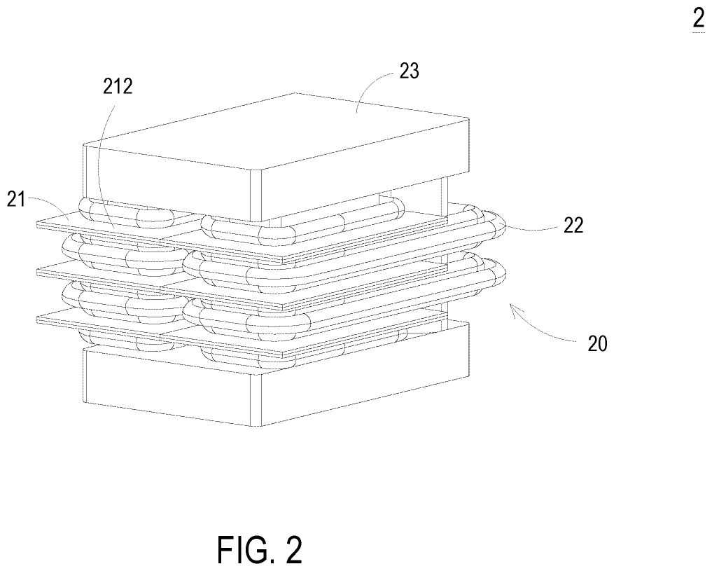

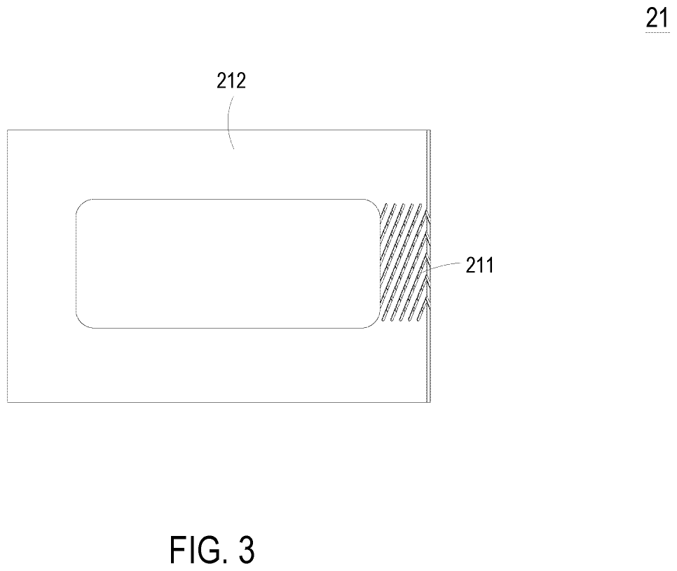

In one embodiment, as shown in FIG. 2 and FIG. 3, the magnetic component 2 is configured as an integrated magnetic component combining a transformer and an inductor. In this embodiment, the hybrid winding structure 20 is wound around at least one leg of the magnetic core 23 and configured to include PCB Litz wire and PCB winding in a same layer, that is, a PCB-based hybrid winding layer 21 including a first portion 211 and a second portion 212. The first portion 211 of the PCB-based hybrid winding layer 21 is configured as PCB Litz wire, and the second portion 212 of the PCB-based hybrid winding layer 21 is configured as PCB winding. In some embodiments, the hybrid winding structure 20 further includes at least one Litz wire layer 22.

In the embodiment, the first portion 211 is disposed at a first magnetic field region of the magnetic component 2, and the second portion 212 is disposed at a second magnetic field region of the magnetic component 2. The magnetic field magnitude of the first magnetic field region is higher than the magnetic field magnitude of the second magnetic field region. Preferably, the first magnetic field region is corresponding to the boundary between the inductor and the transformer.

As used in the embodiments, the “first magnetic field region” and the “second magnetic field region” may be defined based on a spatial magnetic field intensity distribution within the magnetic component during operation. The magnetic field distribution may be determined by electromagnetic simulation, analytical calculation, or experimental measurement under rated operating conditions. In some embodiments, the magnetic field intensity is evaluated along a radial or axial direction relative to a magnetic core leg, and regions exhibiting a higher magnetic field magnitude relative to other regions are defined as the first magnetic field region.

In an embodiment, the at least one Litz wire layer 22 is configured as the primary winding of the magnetic component 2 while the PCB-based hybrid winding layer 21 is configured as the secondary winding of the magnetic component. The inductor winding of the inductor and the primary winding of the transformer are integrated at the primary side of the magnetic component 2. As known, the boundary between the inductor and the transformer often exhibits high magnetic field (i.e., H-fields) due to poor interleaving. Accordingly, the PCB-based hybrid winding layer 21 may have a portion having poor interleaving with the primary winding, leading to strong local magnetic fields and severe AC loss. In response, the first portion 211 of the PCB-based hybrid winding layer 21, namely the PCB Litz wire, is disposed at the first magnetic field region where the magnetic field is stronger, while the second portion 212 of the PCB-based hybrid winding layer 21, namely the PCB winding, is disposed at the second magnetic field region (i.e., remaining areas) with good interleaving where the magnetic field is not strong. As a result, the low DC resistance of PCB winding for the low magnetic field region and the low AC resistance of PCB Litz wire for the high magnetic field region can be leveraged in the same layer of winding. Furthermore, through adapting the Litz wire layer 22, the primary side of the magnetic component 2 is capable of handling higher current loads, while the secondary side of the magnetic component 2 where adapts the PCB-based hybrid winding layer 21 (including PCB winding and PCB Litz wire) is advantageous of small volume, low profile and enhanced thermal dissipation characteristics.

Consequently, in the magnetic component 2 described above, the Litz wire layer 22 manages the high-power, high-current paths, and the first portion 211 with PCB Litz wire of the PCB-based hybrid winding layer 21 is disposed at the region requiring high insulation voltage or compact integration. As a result, the hybrid winding structure 20 of the embodiment of the present disclosure can provide a highly efficient and low-loss solution for complex magnetic structures.

In an embodiment, in the hybrid winding structure of the present disclosure, the quantity of the PCB-based hybrid winding layer 21 is implemented as at least two, and the quantity of the Litz wire layer 22 is implemented as at least one, but not limited thereto, and the quantities of both can be varied in accordance with the practical requirements.

In one embodiment, the magnetic component is configured as a transformer, such as a medium-voltage high-frequency transformer. The primary winding of the transformer utilizes the PCB Litz wire layers to achieve high insulation voltage, while the secondary winding of the transformer utilizes the Litz wire layer to handle higher current loads. Preferably, in the embodiment, based on the magnetic field distribution of the transformer, within multiple middle PCB Liz wire layers, the middle PCB Liz wire layers, which experience a lower magnetic field intensity, are replaced by PCB winding layers to reduce DC losses. The remaining layers exposed to higher magnetic fields are remained as PCB Litz wire layers.

Consequently, in this embodiment, the hybrid winding structure allows for localized optimization of power losses based on the magnetic field distribution. By strategically substituting PCB windings in low magnetic field regions, the structure effectively mitigates the DC resistance penalty typical of full Litz configurations, while maximizing overall conversion efficiency without compromising the high insulation voltage and current-handling capabilities essential for medium-voltage applications.

In another embodiment, the magnetic component is configured as a transformer, such as a step-up transformer. In this embodiment, the secondary side of the transformer is subjected to higher voltage stress, and the secondary winding may be implemented using the PCB winding layer and the PCB Litz wire layer to enhance insulation reliability. On the other hand, the primary winding may utilize the Litz wire layer to handle higher current density. Accordingly, the hybrid winding structure of the present disclosure may be universally applicable to various transformers to optimize the balance among power loss, insulation quality, and volume without limitation.

In some other embodiments, the hybrid winding structure of the present disclosure can be applied to any suitable magnetic component. Also, in accordance with the practical requirements, the hybrid winding structure can be configured to combine different type of winding. The PCB-based hybrid winding layer 21 combining PCB winding and PCB Litz wire as shown in FIG. 3, the PCB winding layer 12 and the PCB Litz wire layer 11 as shown in FIG. 1A to FIG. 1C, and the Litz wire layer 22 as shown in FIG. 2 can be selectively employed in the hybrid winding structure of the embodiment of the present disclosure depending on the tradeoff among cost, volume and performance without limitation.

In the embodiment, a PCB Litz wire of the first portion 211 and PCB winding of the second portion 212 of one of the at least two of the PCB-based hybrid winding layers 21 are within a same conductive plane, and the first portion 211 and the second portion 212 are spatially arranged based on a magnetic field distribution of the magnetic component. In one embodiment, a PCB Litz wire of the first portion 211 and a PCB winding of the second portion 212 of each of the at least two of the PCB-based hybrid winding layers 21 are within the same conductive plane.

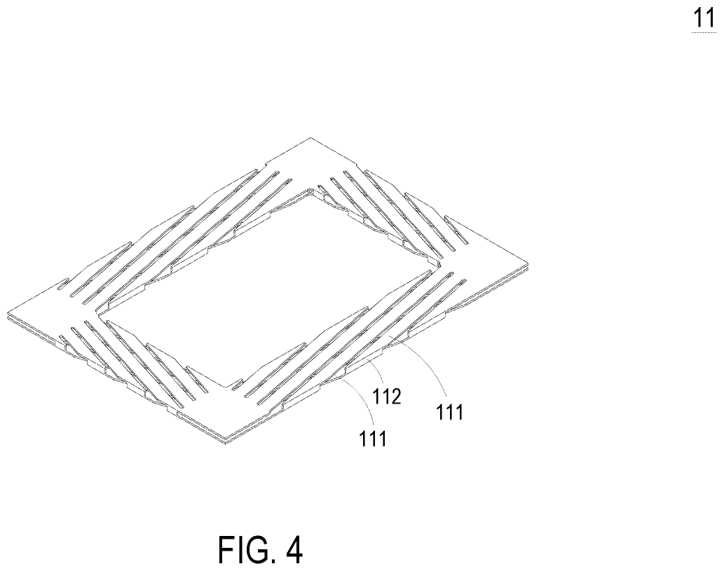

Furthermore, as known, the PCB Litz wire layer includes a plurality of conductive layers, and conventionally, the conductive layers are interconnected with each other through via holes that may create current bottleneck. In one embodiment, as shown in FIG. 4, the interconnection and transposition of the conductive layers 111 in the PCB Litz wire layer 11 are realized through a side plating (also referred to as edge plating) process. Each of the conductive layers 111 forming the PCB Litz wire structure is electrically coupled via a plating layer 112 disposed along at least one edge surface of the printed circuit board to establish a continuous connection path. The side-plating-based interconnection can provide a substantially larger conductive area compared to conventional vias hole, thereby overcoming the DC resistance bottleneck of PCB Litz wire. Consequently, the side plating process not only minimizes DC resistance but also maintains low AC loss, which benefits of the multi-stranded configuration of PCB Litz wire.

Further, in the embodiments, the side plating process is not limited to replacing via-based interconnections, but may also be employed to facilitate current transposition, reduce localized current crowding, and improve thermal conduction along the edge surfaces of the printed circuit board.

Notably, contrary to conventional design intuition that favors uniform conductor types across an entire winding, the hybrid winding structure of the embodiments of the present disclosure intentionally introduces spatial non-uniformity in conductor configuration to achieve an overall optimized loss profile.

In conclusion, through selectively arranging PCB winding, PCB Litz wire, and/or Litz wire based on the magnetic field distribution of the magnetic component, the hybrid winding structure of the embodiment overcomes the technical contradictions between efficiency, insulation, and cost in high-frequency power electronics. By strategically leveraging the low DC resistance of PCB winding and the superior AC loss suppression of PCB Litz wire, the hybrid winding structure of the embodiment provides unmatched flexibility. Moreover, by integrating Litz wire layer to handle high current loads, such as in the secondary winding of transformer or the primary winding of integrated magnetic component, optimal power handling and efficiency can be further achieved. The embodiment of the present disclosure delivers a critical solution for increasing energy density and overall operational efficiency while maintaining a small volume of the hybrid winding structure across various magnetic components.

While the disclosure has been described in terms of what is presently considered to be the most practical embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A hybrid winding structure for a magnetic component, the magnetic component comprising a magnetic core having at least one leg, the hybrid winding structure comprising:
at least two PCB-based hybrid winding layers wound around the at least one leg of the magnetic core, wherein at least one of the at least two PCB-based hybrid winding layers comprises a first portion and a second portion,
wherein the first portion is configured as PCB Litz wire and disposed at a first magnetic field region of the magnetic component, the second portion is configured as PCB winding and disposed at a second magnetic field region of the magnetic component, and a magnetic field magnitude of the first magnetic field region is higher than a magnetic field magnitude of the second magnetic field region.

2. The hybrid winding structure as claimed in claim 1, wherein a ratio of AC resistance to DC resistance of the first magnetic field region is greater than a predefined threshold value, and a ratio of AC resistance to DC resistance of the second magnetic field region is less than a predefined threshold value.

3. The hybrid winding structure as claimed in claim 2, wherein the predefined threshold value equals 3.

4. The hybrid winding structure as claimed in claim 1, wherein the magnetic component is an integrated magnetic component comprising a transformer and an inductor, and the first portion of the at least one of the at least two PCB-based hybrid winding layers is disposed at a boundary between the transformer and the inductor.

5. The hybrid winding structure as claimed in claim 4, further comprising at least one Litz wire layer disposed at the first magnetic field region of the magnetic component.

6. The hybrid winding structure as claimed in claim 1, wherein the first portion and the second portion of the at least one of the at least two of the PCB-based hybrid winding layers are within a same conductive plane, and the first portion and the second portion are spatially arranged based on a magnetic field distribution of the magnetic component.

7. The hybrid winding structure as claimed in claim 1, further comprising at least one Litz wire layer, wherein the at least one Litz wire layer is configured as one of a primary winding and a secondary winding of the magnetic component, and the at least two PCB-based hybrid winding layers are configured as the other of the primary winding and the secondary winding of the magnetic component.

8. The hybrid winding structure as claimed in claim 1, further comprising at least one PCB winding layer wound around the at least one leg of the magnetic core.

9. The hybrid winding structure as claimed in claim 1, wherein the PCB Litz wire of the first portion is formed by using a side plating process.

10. The hybrid winding structure as claimed in claim 1, wherein each of the at least two PCB-based hybrid winding layers comprises the first portion disposed at the first magnetic field region of the magnetic component and the second portion disposed at the second magnetic field region of the magnetic component.

11. A hybrid winding structure for a magnetic component, the magnetic component comprising a magnetic core having at least one leg, the hybrid winding structure comprising:
at least one PCB Litz wire layer; and
at least one PCB winding layer,
wherein the at least one PCB Litz wire layer and the at least one PCB winding layer are stacked on each other and wound around the at least one leg of the magnetic core;
wherein the at least one PCB Litz wire layer is disposed at a first magnetic field region of the magnetic core, the at least one PCB winding layer is disposed at a second magnetic field region of the magnetic core, and a magnetic field magnitude of the first magnetic field region is higher than a magnetic field magnitude of the second magnetic field region.

12. The hybrid winding structure as claimed in claim 11, wherein the magnetic component comprises an inductor, and the first magnetic field region is corresponding to or proximate to an air gap of the magnetic component.

13. The hybrid winding structure as claimed in claim 11, wherein the magnetic component comprises a transformer, and the at least one PCB Litz wire layer and the at least one PCB winding layer are configured as at least one of a primary winding and a secondary winding of the transformer.

14. The hybrid winding structure as claimed in claim 13, further comprising at least one Litz wire layer configured as the other of the primary winding and the secondary winding of the transformer.

15. The hybrid winding structure as claimed in claim 11, wherein the at least one PCB Litz wire layer comprises two PCB Litz wire layers, and the at least one PCB winding layer is located between the two PCB Litz wire layers.

16. The hybrid winding structure as claimed in claim 11, wherein a plurality of conductive layers in each of the at least one PCB Litz wire layer are interconnected through a side plating process.
